(19) United States
(12) Patent Application Publication
(10) Pub. No.: US 2009/0285958 A1
(43) Pub. Date: Nov. 19, 2009

(54) System and methods for food processing

(76) Inventor: Jorge B. Garcia, Rogers, AR (US)

Correspondence Address: K&L GATES LLP, 535 SMITHFIELD STREET, PITTSBURGH, PA, 15222, US

(21) Appl. No.: 12/152,527

(22) Filed: May 15, 2008

(51) Int. Cl. A47J 43/046

(52) U.S. Cl. 426/519; 366/199; 366/314

(57) ABSTRACT

Various embodiments are directed to methods of operating a food processing device. The food processing device may comprise a blade configured to rotate about a vertically oriented axis. The methods may comprise performing a plurality of rotation cycles. Each rotation cycle may comprise a first period during which the blade is rotated at a first rotation speed and a second period during which the blade is rotated at a second rotation speed. The first rotation speed may increase between successive rotation cycles, while the second rotation speed may be constant across the plurality of rotation cycles. Also, all values of the first rotation speed may be greater than the second rotation speed.

### BACKGROUND

The present disclosure relates to processing machines, such as blenders, food processors, mixers, etc., that have a blade configured to rotate about a vertically oriented axis. For example, the present disclosure relates to systems and methods for operating a processing machine to optimize its performance.

### SUMMARY

In one aspect, the present disclosure is directed to methods of operating a food processing device. In one embodiment, the food processing device may comprise a blade configured to rotate about a vertically oriented axis. The methods may comprise performing a plurality of rotation cycles. Each rotation cycle may comprise a first period during which the blade is rotated at a first rotation speed and a second period during which the blade is rotated at a second rotation speed. The first rotation speed may increase between successive rotation cycles, while the second rotation speed may be constant across the plurality of rotation cycles. Also, all values of the first rotation speed may be greater than the second rotation speed.

In another embodiment, the methods may comprise performing a plurality of rotation cycles. Each rotation cycle may comprise a first period during which the blade is rotated at a first rotation speed and a second period during which the blade is rotated at a second rotation speed. The first rotation speed may be higher than the second rotation speed, and the first period may be longer than the second period. After performing the plurality of rotation cycles, the methods may also comprise rotating the blade at a third rotation speed for a third period. The third rotation speed may be less than the first rotation speed and greater than the second rotation speed. Also, the second period may be longer than the first period.

In yet another embodiment, the methods may comprise rotating the blade at a first rotation speed for a first period. After rotating the blade at the first rotation speed for the first period, the methods may comprise performing a plurality of rotation cycles. Each rotation cycle may comprise a first cycle period during which the blade is rotated at a second rotation speed and a second cycle period during which the blade is rotated at a third rotation speed. The third rotation speed may be higher than the second rotation speed. Also, the first rotation speed may be higher than the third rotation speed. After the plurality of rotation cycles, the methods may comprise rotating the blade at the first rotation speed for the first period.

### FIGURES

Embodiments of the present invention are described herein, by way of example, in conjunction with the following figures, wherein:

FIG. 1 illustrates one embodiment of a blender processing machine;

FIG. 2 illustrates a block diagram showing one embodiment of a processing machine;

FIG. 3 illustrates a diagram showing one embodiment of a rotation speed sequence for the processing machine of FIG. 2;

FIG. 4 illustrates a diagram showing one embodiment of a rotation speed sequence for the processing machine of FIG. 2 comprising a ramp period;

FIG. 5 illustrates a diagram showing one embodiment of a rotation speed sequence for the processing machine of FIG. 2; and

FIG. 6 illustrates a diagram showing one embodiment of a rotation speed sequence for the processing machine of FIG. 2

### DESCRIPTION

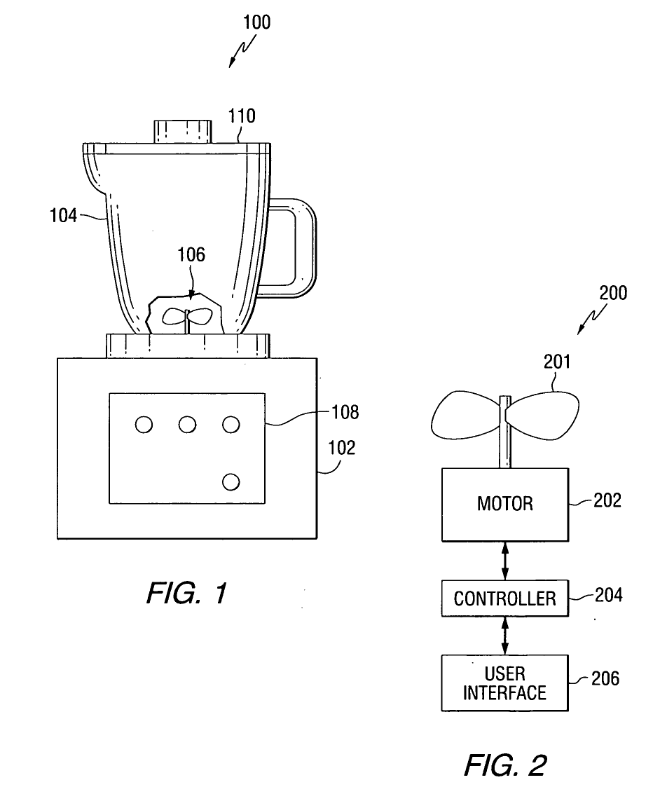

FIG. 1 illustrates one embodiment of a blender processing machine 100. The blender 100 may comprise a base unit 102 and a jar 104. The base unit 102 may comprise a motor (not shown) and a user interface 108. The jar 104 may comprise a lid 110 and a blade 106 coupled to the motor. The shape of the blade 106 may be optimized based on the desired use of the blender 100. For example, a blade 106 configured for shredding may comprise one or more tines having sharp edges designed to cut through food or other material. A blade 106 configured for mixing may comprise one or more paddles having dull or flat edges configured to mix or agitate material. Any suitable blade configuration may be used. According to various embodiments, the blender 100 may be compatible with multiple blades, which may be interchanged for different processing applications.

In use, food or other material, may be introduced into the jar 104. The blade 106 may then be rotated, causing mixing, shredding, or other agitation of the material in the jar 104. Generally, the blade 106 may create a vortex or other flow pattern directing liquid and/or fine solid material present in the jar 104 to the blade 106, where it is shredded, mixed or otherwise agitated. Often, however, there are dead spots in the flow pattern. Material in these dead spots may not be directed to the blade, resulting in incomplete processing. Similar effects are experienced with food processors and other processing machines. Various embodiments are directed to systems and methods for manipulating the rotation speed of a processing machine blade to periodically break and/or weaken the vortex or other flow pattern and allow solid materials to settle out of flow pattern dead spots and reach the blade 106.

FIG. 2 illustrates a block diagram showing one embodiment of a processing machine 200. A motor 202 may be coupled to and configured to rotate a blade 201. The motor 202 may be any suitable type of motor including, for example, a direct current (DC) motor, an alternating current (AC) motor, an internal combustion engine, etc. The motor 202 may be coupled to the blade 201 according to any suitable configuration. For example, the motor 202 may be directly coupled to the blade 201, or may be coupled to the blade 201 via one or more belts, gears, etc. (not shown). The machine 200 may also comprise a controller 204. The controller 204 may be configured to control the rotation of the blade 201. For example, the controller 204 may manipulate the rotational speed of the motor 202. According to various embodiments, the controller 204 may also control the rotation of the blade 201 by manipulating a coupling between the motor 202 and the blade 201 (e.g., a transmission).

The controller 204 may include any suitable component type. For example, the controller 204 may comprise an analog control circuit (not shown). According to various embodiments, the controller 204 may comprise a digital control circuit such as, for example, a programmable logic controller (PLC), any other type of microprocessor, a state machine, or any other suitable type of digital control circuit. According to various embodiments, the controller 204 may be configured to rotate the blade 201 according to a predetermined program or sequence, for example, as described herein below. A user interface 206 may allow a user to operate and/or observe a status of the processing machine 200. For example, the user may utilize the interface 206 to turn the machine 200 on or off; select a rotation speed of the blade 201; and/or select a predetermined blade program. The user interface 206 may have any suitable input components including, for example, button-type switches, one or more touch-screens, etc. Various embodiments of the interface 206 may also include output components including, for one or more light emitting diodes (LED's), backlit switches, LED displays, screens, etc.

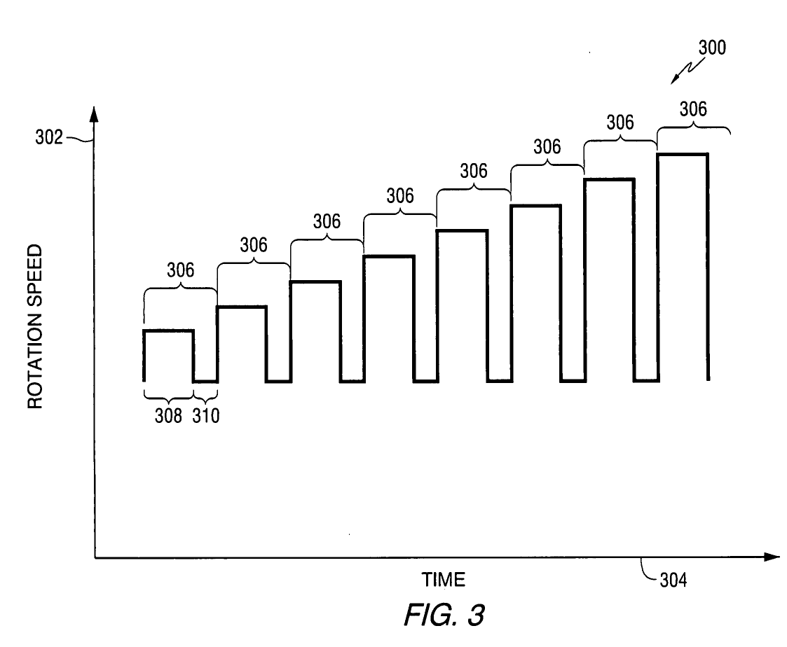

FIG. 3 illustrates a diagram showing one embodiment of a rotation speed sequence 300 for the processing machine 200. The Y-axis 302 illustrates a rotation speed of the blade 201, while the X-axis 304 illustrates time. The sequence 300 may comprise a plurality of rotation cycles 306. Each of the rotation cycles 306 may comprise a high rotation speed period 308 and a low rotation speed period 310. The rotation speed of the blade 201 may be the same across all of the low rotation speed periods 310. During the high rotation speed periods 308, however, the blade's rotation speed may increase with each successive cycle 306, as shown. According to various embodiments, the lowest rotation speed during the high rotation speed periods 308 may be higher than the constant rotation speed of the blade 201 during the low rotation speed periods 310. According to various embodiments, the constant rotation speed of the blade 201 during the low rotation speed periods 310 may be zero or any non-zero value.

The number of cycles 306 in the sequence 300 may vary, and may be determined according in any suitable manner. For example, the controller 204 may be configured and/or programmed to perform a predetermined number of cycles 306 such as, for example, twelve cycles. Also, for example, the controller 204 may be configured and/or programmed to continue the sequence 300 until a predetermined amount of time (e.g., three minutes) has passed. The predetermined number of cycles and/or amount of time may be pre-programmed into the controller 204, or may be received from a user via the user interface 206. According to various embodiments, the user may truncate the sequence 300 by selecting an appropriate input from the user interface 206.

The duration of each rotation cycle 306, as well as the selected rotation speeds and the increase in rotation speed between successive high rotation speed periods 308 may be varied. For example, cycle duration and rotation speeds may be tuned to the component configuration of a particular processing machine 200. For example, the processing machines 200 with different motors 202, blades 201, jars 104, and combinations thereof, may behave differently, and therefore, may be tuned differently. According to various embodiments, tuning for a processing machine 200 having a given component combination may be performed once. The cycle durations and rotation speeds resulting from the tuning may then be applied to other processing machines 200 having the same or a similar component configuration.

The cycle duration and rotation speeds for processing machines 200 having a given component combination may be performed in any suitable way. For example, in various embodiments, a high rotation speed period 308 may be implemented and maintained until the occurrence of a threshold event. The threshold event may be an event indicating that the effectiveness of the blade 201 has been reduced. When the threshold event occurs, the high rotation speed period 308 may end. A low rotation speed period 310 may then be maintained until the threshold event abates. Any suitable occurrence may serve as a threshold event. For example, a threshold event may occur when solid material is suspended on a vortex and is not reaching the blade. In addition, or instead, a threshold event may occur when an air bubble forms above the blade 201 that, at least partially, blocks the access of materials to the blade 201. According to some embodiments, the threshold event may occur when the materials reach a predetermined consistency level. To affect the cycle duration, the rotation speeds of the high rotation speed period 308 and the low rotation speed period 310 may be modified.

Table 1 below illustrates an example of the sequence 300. Period 1 may refer to the high rotation speed periods 308, while Period 2 may refer to the low rotation speed periods 310. Although the cycle 306 is described above with the high rotation speed period 308 occurring before the low rotation speed period 310, it will be appreciated that the order of the various periods within each cycle may be reversed without affecting the results.

TABLE 1

| | Period 1 | | Period 2 | |
|---|---|---|---|---|
| Cycle | (RPM) | (Sec) | (RPM) | (Sec) |
| 1 | 11,000 | 10 | 7000 | 5 |
| 2 | 11,800 | 10 | 7000 | 5 |
| 3 | 12,600 | 10 | 7000 | 5 |
| 4 | 13,400 | 10 | 7000 | 5 |
| 5 | 14,200 | 10 | 7000 | 5 |
| 6 | 15,000 | 10 | 7000 | 5 |
| 7 | 15,900 | 10 | 7000 | 5 |
| 8 | 16,700 | 10 | 7000 | 5 |
| 9 | 17,600 | 10 | 7000 | 5 |
| 10 | 18,400 | 10 | 7000 | 5 |
| 11 | 19,200 | 10 | 7000 | 5 |
| 12 | 20,000 | 10 | 7000 | 5 |

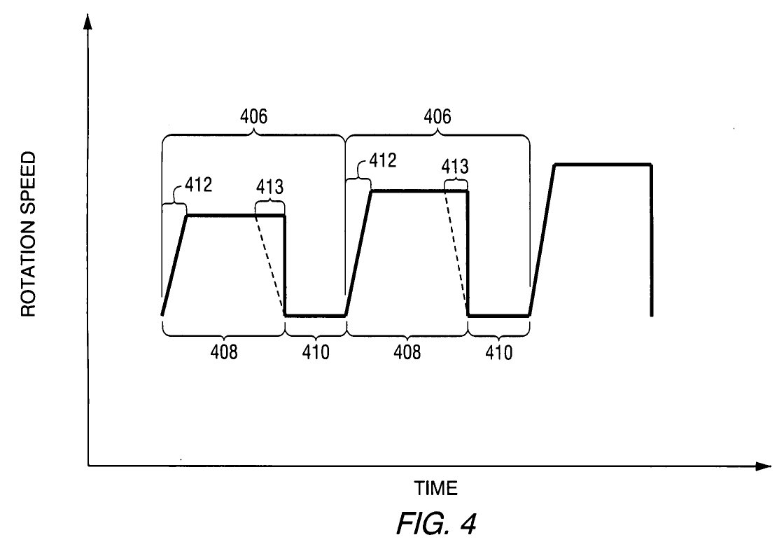

FIG. 4 illustrates a diagram showing one embodiment of a rotation speed sequence 400 for the processing machine 200 comprising a ramp period. Ramping the blade 201 rotation speed up to a higher rotation speed (e.g., during a ramp-up period 412) or down to a lower rotation speed (e.g., during a ramp-down period 413) may prevent excessive wear on the motor 202. The sequence 400 has a configuration similar to that of the sequence 300 above, however, it will be appreciated that any sequence where the blade 201 transitions between different rotation speeds may utilize a ramp-up 412 or ramp down 413 period.

The sequence 400 may comprise a plurality of cycles 406, with each cycle comprising a high rotation speed period 408 and a low rotation speed period 410. A ramp-up period 412 is also included and may represent a period over which the blade 201 is ramped up to a higher speed. For the purpose of determining cycle and period length, the ramp-up period 412 may be considered a portion of: (1) the high rotation speed period 408, (2) the preceding low rotation speed period 410, and/or (3) it may be considered as a period independent of periods 408, 410. During a ramp-down period 413 (shown in with phantom lines), the rotation speed of the blade 201 may be reduced from a relatively high speed to a lower speed gradually. Again, this may prevent excessive wear on the motor 202. The duration and rotation speeds for the periods 408, 410 may be tuned to particular component configurations, for example, as described herein. Also, it will be appreciated that the order of the various periods within each cycle 406 may be re-arranged and/or reversed.

The duration of a ramp-up 412 or ramp-down period 413 may be determined, for example, based on the requirements of the motor. According to various embodiments, a ramp-up 412 or ramp-down 413 period may comprise twenty percent of the overall period. For example, if a high rotation speed 408 period has a duration of ten seconds, the ramp-up period 412 may take up the first two seconds. Motor related concerns may also affect the lowest rotation speed of the motor 202 during a sequence. For example, some motors may tend to overheat if they are maintained at zero rotation speed. Accordingly, when motors such as these are used, it may be desirable to pick a non-zero value for the lowest rotation speed of the motor 202.

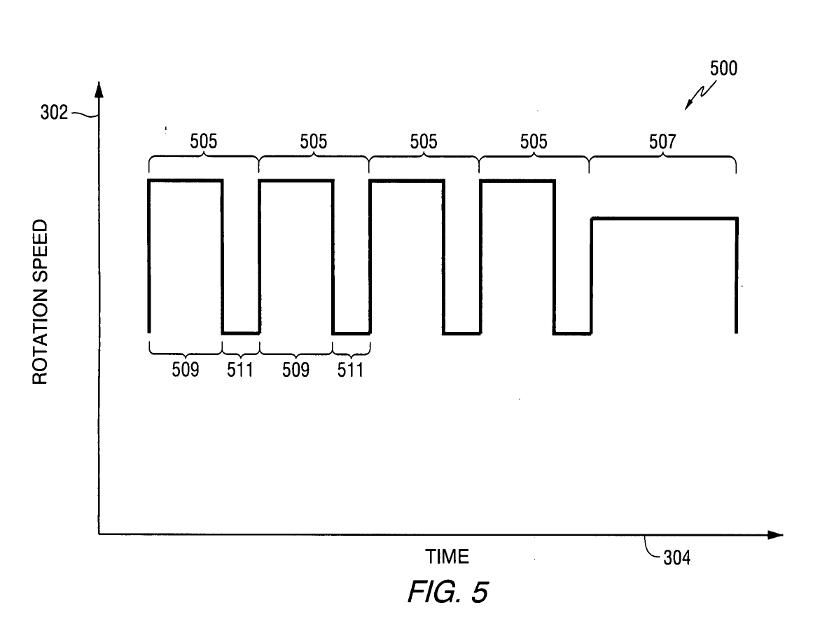

FIG. 5 illustrates a diagram showing one embodiment of a rotation speed sequence 500 for the processing machine 200. The sequence 500 may be adapted for mixing liquid or predominantly liquid material. Like the sequences 300 and 400, the sequence 500 may comprise a plurality of cycles 505. Each cycle may include a high rotation speed period 509 and a low rotation speed period 511. The rotation speed of the blade 201 may be constant across all high rotation speed periods 509 and across all low rotation speed periods 511, as shown. At the conclusion of the cycles 505, the sequence 500 may include an additional period 507, where the blade 201 is rotated at a speed that is less than the rotation speed of the high rotation speed periods 509, but higher than the rotation speed of the low rotation speed periods 511. According to various embodiments, one or more additional periods (e.g., high rotation speed periods 509 and/or low rotation speed periods 511) may be inserted between the last full cycle 505 and the additional period 507. Also, according to various embodiments, one or more cycles 505 may include an intermediate speed cycle (not shown) positioned between the high rotation speed periods 509 and the low rotations peed periods 511.

According to various embodiments, the duration of the cycles 505 and periods 507, 509, 511 as well as their respective rotation speeds may be determined according to any suitable method. For example, the duration of the high rotation speed period 509 may be twice the duration of the low rotation speed period 511, while the duration of the additional period 507 may be twice the duration of the high rotation speed period 509. Specific period durations may be tuned to a given component configuration, for example, as described herein. Also, it will be appreciated that the order of periods 509, 511 may be reversed. Table 2 below illustrates an example implementation of the sequence 500:

TABLE 2

| | Speed | Time |
|---|---|---|
| | (RPM) | (Sec) |
| Cycle 1 | 20,000 | 10 |
| | 7,000 | 5 |
| Cycle 2 | 20,000 | 10 |
| | 7,000 | 5 |
| Additional | 14,200 | 20 |
| Period | | |

The number of cycles 505 performed before the additional period 507 may vary, and may be determined according to any suitable method. For example, the controller 204 may be programmed to perform a predetermined number of cycles 505, or to perform cycles 505 for a predetermined amount of time. The number of cycles and/or the amount of time may be pre-programmed into the controller 204, or may be received from a user via the user interface 206. According to various embodiments, the user may also be able to truncate the sequence 500 during one of the cycles 505, for example, via the user interface 206. This may cause the controller 206 to begin the additional period 507 at the conclusion of the current cycle 505.

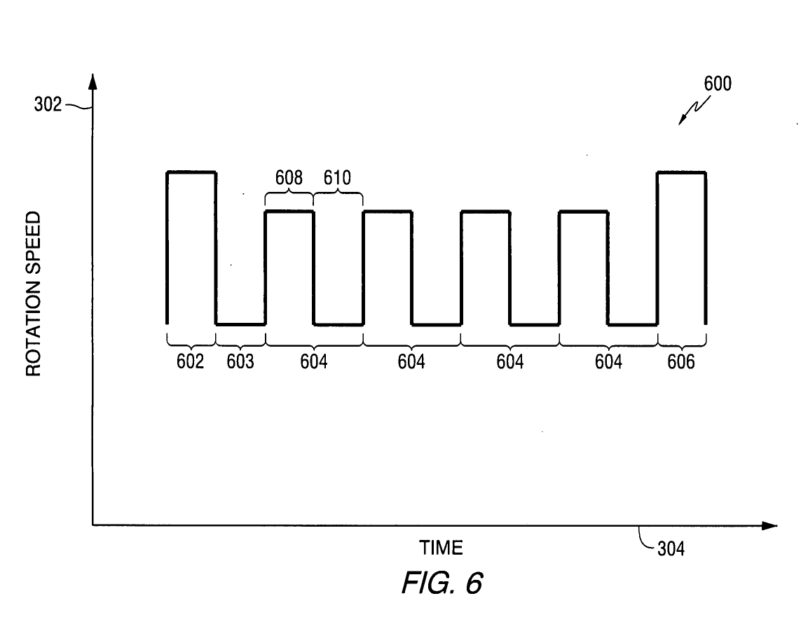

FIG. 6 illustrates a diagram showing one embodiment of a rotation speed sequence 600 for the processing machine 200. The sequence 600 may be optimized for mixing and/or shredding solid or predominantly solid material. The sequence 600 may comprise a plurality of cycles 604 between a start period 602 and a stop period 606. Each cycle may comprise a high rotation speed period 608 and a low rotation speed period 610. One or more partial cycle periods 603 may be inserted between the start period 602, the stop period 606 and the plurality of cycles 604. The rotation speed of the blade 201 during the start period 602 and the stop period 606 may be higher than the rotation speed of the blade during the high rotation speed periods 608. According to various embodiments, the duration of the periods 602, 603, 608, and 610 may be equal. Also, according to various embodiments one or more of the cycles 604 may include an intermediate speed period (not shown) between a high rotation speed period 608 a low rotation speed period 610.

The number of the various cycles 604 and periods 602, 603, 606 in the sequence 600, as well as the rotation speeds thereof, may vary and may be determined according to any suitable method. For example, the lengths of periods 608, 610 may be tuned to a given component configuration, as described herein. Also, it will be appreciated that the timing of periods 608, 610 may be reversed. For example, Tables 3 and 4 below illustrate example embodiments of the sequence 600:

TABLE 3

| Period | (RPM) | (Sec) |
|---|---|---|
| 1 | 14,200 | 5 |
| 2 | 7,000 | 5 |
| 3 | 11,000 | 5 |
| 4 | 7,000 | 5 |
| 5 | 11,000 | 5 |
| 6 | 7,000 | 5 |
| 7 | 11,000 | 5 |
| 8 | 7,000 | 5 |
| 9 | 11,000 | 5 |
| 10 | 7,000 | 5 |
| 11 | 11,000 | 5 |
| 12 | 7,000 | 5 |
| 13 | 14,200 | 5 |

TABLE 4

| Period | (RPM) | (Sec) |
|---|---|---|
| 1 | 14,200 | 5 |
| 2 | 7,000 | 5 |
| 3 | 13,400 | 5 |
| 4 | 7,000 | 5 |
| 5 | 13,400 | 5 |
| 6 | 7,000 | 5 |
| 7 | 13,400 | 5 |
| 8 | 7,000 | 5 |
| 9 | 13,400 | 5 |
| 10 | 7,000 | 5 |
| 11 | 13,400 | 5 |
| 12 | 7,000 | 5 |
| 13 | 14,200 | 5 |

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

We claim:

1. A method of operating a food processing device comprising a blade configured to rotate about a vertically oriented axis, the method comprising:
performing a plurality of rotation cycles, wherein each rotation cycle comprises a first period during which the blade is rotated at a first rotation speed and a second period during which the blade is rotated at a second rotation speed;
wherein the first rotation speed increases between successive rotation cycles;
wherein the second rotation speed is constant across the plurality of rotation cycles; and
wherein all values of the first rotation speed are greater than the second rotation speed.

2. The method of claim 1, wherein the duration of the first period is greater than the duration of the second period.

3. The method of claim 2, wherein the duration of the first period is ten seconds and the duration of the second period is five seconds.

4. The method of claim 1, further comprising tuning the durations of the first period and the second period to a component configuration of the food processing device.

5. The method of claim 4, wherein the tuning the durations of the first period and the second period comprises:
maintaining the first period until the occurrence of a threshold event;
transitioning to the second period; and
maintaining the second period until the threshold event abates.

6. The method of claim 5, wherein the threshold event is selected from the group consisting of: development of a vortex that prevents unprocessed material from reaching the blade, an air bubble forming around the blade, and processed material reaching a predetermined consistency.

7. The method of claim 1, wherein the plurality of rotation cycles comprises twelve cycles.

8. The method of claim 7, wherein the first rotation speed has a value of 11,000 RPM during a first cycle of the plurality of cycles, and increases to a value of 20,000 RPM during a twelfth cycle of the plurality of cycles.

9. The method of claim 1, wherein the second rotation speed is non-zero.

10. The method of claim 1, wherein the blade is ramped up to the first rotation speed during the first period over a ramp-up period.

11. The method of claim 10, wherein the transition period is at least 20% of the first period.

12. The method of claim 1, wherein the food processing device is selected from the group consisting of a blender and a food processor.

13. A method of operating a food processing device comprising a blade configured to rotate about a vertically oriented axis, the method comprising:
performing a plurality of rotation cycles, wherein each rotation cycle comprises a first period during which the blade is rotated at a first rotation speed and a second period during which the blade is rotated at a second rotation speed, wherein the first rotation speed is higher than the second rotation speed, and wherein the first period is longer than the second period; and
after performing the plurality of rotation cycles, rotating the blade at a third rotation speed for a third period, wherein the third rotation speed is less than the first rotation speed and greater than the second rotation speed, and wherein the second period is longer than the first period.

14. The method of claim 13, further comprising tuning the durations of the first period and the second period to a component configuration of the food processing device.

15. The method of claim 14, wherein the tuning the durations of the first period and the second period comprises:
maintaining the first period until the occurrence of a threshold event;
transitioning to the second period; and
maintaining the second period until the threshold event abates.

16. The method of claim 15, wherein the threshold event is selected from the group consisting of: development of a vortex that prevents unprocessed material from reaching the blade, an air bubble forming around the blade, and processed material reaching a predetermined consistency.

17. The method of claim 13, wherein the second rotation speed is non-zero.

18. The method of claim 13, wherein the first period is twice the second period.

19. The method of claim 13, wherein the first period is 10 seconds and the second period is 5 seconds.

20. The method of claim 13, wherein the third period is twice the first period.

21. The method of claim 13, wherein the first period is 10 seconds and the second period is 20 seconds.

22. The method of claim 13, wherein the first rotation speed is 20,000 RPM, the second rotation speed is 7,000 RPM and the third rotation speed is 14,200 RPM.

23. The method of claim 13, wherein the blade is ramped up to the first rotation speed during the first period over a ramp-up period.

24. The method of claim 13, wherein at least one of the rotation cycles further comprises a third period during which the blade is rotated at a third rotation speed, wherein the third rotation speed is less than the first rotation speed and greater than the second rotation speed.

25. A method of operating a food processing device comprising a blade configured to rotate about a vertically oriented axis, the method comprising:
rotating the blade at a first rotation speed for a first period;
after rotating the blade at the first rotation speed for the first period, performing a plurality of rotation cycles, wherein each rotation cycle comprises a first cycle period during which the blade is rotated at a second rotation speed and a second cycle period during which the blade is rotated at a third rotation speed, wherein the third rotation speed is higher than the second rotation speed, and wherein the first rotation speed is higher than the third rotation speed; and
after the plurality of rotation cycles, rotating the blade at the first rotation speed for the first period.

26. The method of claim 25, further comprising tuning the durations of the first period and the second period to a component configuration of the food processing device.

27. The method of claim 26, wherein the tuning the durations of the first cycle period and the second cycle period comprises:
maintaining the first cycle period until the occurrence of a threshold event;
transitioning to the second cycle period; and
maintaining the second cycle period until the threshold event abates.

28. The method of claim 27, wherein the threshold event is selected from the group consisting of: development of a vortex that prevents unprocessed material from reaching the blade, an air bubble forming around the blade, and processed material reaching a predetermined consistency.

29. The method of claim 25, wherein at least one of the plurality of rotation cycles comprises a third cycle during which the blade is rotated at a fourth rotation speed, wherein the fourth rotation speed is lower than the third rotation speed and higher than the second rotation speed.

30. The method of claim 25, wherein the first rotation speed is 14,200 RPM and the third rotation speed is 7000 RPM.

31. The method of claim 25, wherein the second rotation speed is selected from the group consisting of 11,000 RPM and 13,400 RPM.

32. The method of claim 25, wherein the third rotation speed is non-zero.

33. The method of claim 25, wherein the blade is ramped up to the first rotation speed during the first period over a ramp-up period.

34. The method of claim 25, wherein the first period is 5 seconds.

35. The method of claim 25, wherein the first cycle period and the second cycle period are equal to the first period.
